(19) United States
(12) Patent Application Publication
(10) Pub. No.: US 2008/0266206 A1
(43) Pub. Date: Oct. 30, 2008

(54) Modular System for a Display Panel Assembly

(75) Inventors: William R. Nelson, Waukesha, WI (US); Patrick J. Armstrong, Menomonee Falls, WI (US); Yavuz S. Saglam, Sussex, WI (US)

Correspondence Address: FOLEY & LARDNER LLP, 777 EAST WISCONSIN AVENUE, MILWAUKEE, WI, 53202-5306, US

(73) Assignee: ADAPTIVE MOCRO SYSTEMS LLC

(21) Appl. No.: 11/884,173

(22) PCT Filed: Mar. 11, 2005
(86) PCT No.: PCT/US2005/008318

§ 371 Date: Aug. 10, 2007

(51) Int. Cl. G09G 5/00

(52) U.S. Cl. 345/1.3

(57) ABSTRACT

A modular system for a display panel assembly includes modular frame members connectable to form a network. Bus bars are connectable to the frame members and are configured to at least partially support the frame members in a row or column of frame members in the network. Modular display units are connectable to the frame members to form a display panel assembly.

### FIELD

The present invention relates to a modular system for a display panel assembly. The present invention relates more particularly to a modular system for assembling an illuminated electronic display panel in a wide variety of sizes and/or shapes.

### BACKGROUND

Electronic display panels (such as message boards and alphanumeric signs) for conveying information such as messages and other types of information to an observer are generally known. Such display panels may include illumination devices such as an array of light emitting diodes (LEDs) configured to illuminate in predetermined colors and/or patterns to create words (in any suitable language) or images for conveying information to observers. The physical size of such display panels may be any of a wide variety of sizes suited for the intended application, and range from relatively “small” (e.g. applications intended for “up-close” viewing) to relatively “large” (e.g. applications intended for distant viewing).

Many conventional display panels are custom manufactured to the desired size intended or specified for a particular application. However, one disadvantage is that such custom-manufactured units tend to be relatively expensive and time-consuming to construct. More recently, display panels (such as large display panels) may also be constructed by assembling “smaller” display panels (e.g. sub-panels) into a “larger” size display panel as necessary for the intended application. However, one disadvantage of assembling smaller display panels to create a larger sized display panel is that the assembly process is typically a labor-intensive, “factory-assembled” operation due to the complexity of the various mechanical and electrical requirements, and alignment specifications for interconnecting the smaller display panels, which tends to be difficult to accomplish at a jobsite or installation location. Another disadvantage of custom-manufacturing a display panel or assembling a display panel from smaller display panels is that shipment of “finished” large display panels also tends to be more expensive then shipping smaller display panels to a jobsite, and occasionally damage to a large display panel or degradation in the alignment of the various smaller display panels can occur during shipping or installation that is difficult and/or expensive to repair at the installation or jobsite. Another disadvantage of the typical large display signs formed from multiple smaller display signs is that the smaller display signs are usually not designed to support the loading and weight of other smaller display signs in the assembly (e.g. by stacking, etc.) and often require supplemental supports, bracing or framework to maintain the structural integrity of the large display sign. A further disadvantage is that removal and replacement of individual smaller display panels from a large display panel assembly for maintenance, repair and/or replacement is usually complicated, due in part, to the various mechanical and electrical interconnections between the smaller display panels and/or the supplemental supports. Another disadvantage of forming large displays from smaller display panels is the complexity of aligning the smaller display panels so that their pixels provide a uniform appearance to an observer. This potential variation in alignment of the smaller display panels, particularly with “finer” pitched displays (such as less than 12 millimeters for example) tends to be readily detectable by a human eye and may reduce the quality of the display as perceived by an observer.

Therefore, it would be desirable to provide a modular system for assembling a display panel that permits smaller display panel components, units or modules to be assembled into a display panel having any desired size and/or shape. It would also be desirable to provide a modular system for assembling a display panel having features for alignment of the pixels of the smaller display panels that minimizes the potential for mismatch. It would also be desirable to provide a modular system for assembling a display panel that permits components of the display panel to be readily pre-tested and/or assembled at a jobsite. It would also be desirable to provide a modular system for a display panel that permits the display panel to be constructed from modular components into any desired size and shape. It would also be desirable to provide a modular system for a display panel having relatively standardized components that are configured to be easily and correctly assembled at a factory or jobsite location. It would further be desirable to provide a modular system for a display panel that is configured to maintain the structural integrity of the display panel in any of a wide variety of sizes. It would be further desirable to provide a display panel assembled from modular sub-panels that are easily replaceable. It would be further desirable to provide modular sub-panels assembled from a modular display unit connectable to a modular frame member, so that the frame members may be interconnected into a frame network for receiving the modular display units, or the sub-panels may be assembled and then interconnected.

Accordingly, it would be desirable to provide a modular system for a display panel having any one or more of these or other advantageous features.

### SUMMARY

One embodiment of the invention relates to a modular system for a display panel assembly. The system includes a plurality of modular frames connectable into a two-dimensional matrix of at least one row and at least one column of the frames. At least one power bus is connected along frames of the or the column. A plurality of modular display units are connectable to the frames and the power bus, and a communication device configured to communicate signals to the display units.

Another embodiment of the invention relates to a modular display system. The system includes a plurality of modular frame members connectable to form a network. At least one bus bar is connectable to the frame members and configured to at least partially support the frame members in one of a row and a column of frame members in the network. A plurality of modular display units are connectable to the frame members to form a display panel assembly.

Another embodiment of the invention relates to a modular frame member for receiving a modular display element of a display panel assembly. The frame member includes a base, with a socket and a projection coupled to the base. The socket on the base is configured to receive the projection on another base to connect and align adjacent frame members. A connecting structure on the base is configured to receive the display element.

A further embodiment of the invention is related to a method of assembling a modular display panel. The method includes requesting that a plurality of interconnectable modular frames and modular display units be transported to a first location, connecting the frames at the first location to form a network, connecting at least one bus bar to at least one of a row and a column of frames in the network, and connecting a plurality of modular display units to the frames.

### BRIEF DESCRIPTION OF THE DRAWINGS

FIG. 1A is a schematic representation of a front elevation view of a modular system for a display panel according to one embodiment.

FIG. 1B is a schematic representation of a rear elevation view of the modular system for a display panel of FIG. 1A.

FIG. 1C is a schematic representation of a side elevation view of the modular system for a display panel of FIG. 1A.

FIG. 2A is a schematic representation of a front perspective view of the modular system for a display panel of FIG. 1A.

FIG. 2B is a schematic representation of a front perspective view of a portion of the modular system for a display panel of FIG. 1A.

FIG. 2C is a schematic representation of a perspective view of a device for use with a modular system for a display panel according to one embodiment.

FIG. 3A is a schematic representation of an exploded front perspective view of a portion of the modular system for a display panel of FIG. 1A.

FIG. 3B is a schematic representation of a rear perspective view of a portion of the modular system for a display panel of FIG. 3A.

FIG. 3C is a schematic representation of a front elevation view of another portion of the modular system for a display panel of FIG. 3A.

FIG. 3D is a schematic representation of a rear perspective view of another portion of the modular system for a display panel of FIG. 3A.

FIG. 3E is a schematic representation of a rear perspective view of another portion of the modular system for a display panel of FIG. 3A.

FIG. 3F is a schematic representation of a rear perspective view of a modular display unit portion of the modular system for a display panel according to the embodiment of FIG. 3A.

FIG. 4 is a schematic representation of a front perspective view of a portion of the modular system for a display panel of FIG. 1A.

FIG. 5 is a schematic representation of a rear perspective view of the portion of the modular system for a display panel of FIG. 4.

FIG. 6 is a schematic representation of a front perspective view of a portion of the modular system for a display panel of FIG. 1A.

FIG. 7 is a schematic representation of a rear perspective view of the portion of the modular system for a display panel of FIG. 6.

FIG. 8 is a schematic representation of a detailed cross sectional view of a portion of the modular system for the display panel of FIG. 7.

FIG. 9 is a schematic representation of a perspective view of another portion of a modular system for a display panel according to one embodiment.

FIG. 10 is a schematic representation of a perspective view of a portion of the modular system for a display panel of FIG. 9.

### DETAILED DESCRIPTION

Referring to the FIGURES, a modular system for a display panel assembly that may be formed in any of a wide variety of sizes and/or shapes is shown according to one embodiment. The modular system is shown to include relatively standardized components configured to easily interconnect (mechanically and electrically) and align in a certain predetermined fastening arrangement at a factory or jobsite, with a minimum number of external mechanical fasteners as well as electrical connectors and wires, and that provides suitable structural support for the display panel as a whole. The modular system is shown and described for use with a generally planar illuminated display such as a message board or information screen or the like having light emitting diodes (LEDs). However, other embodiments of the modular system may be used with any suitable panel, having any desired shape (e.g. curved, convex, concave, in two or three dimensions, etc.) for conveying images or information, and using any suitable type of illumination devices (e.g. lamps, bulbs, fiber optics, LEDs, LCD panels, plasma displays, etc.).

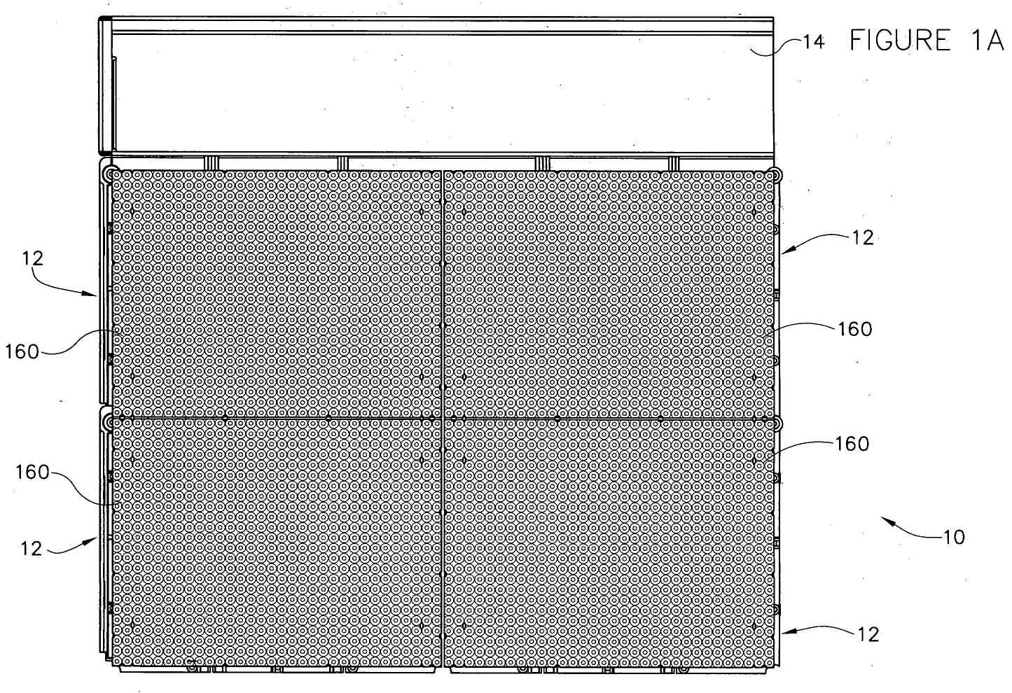

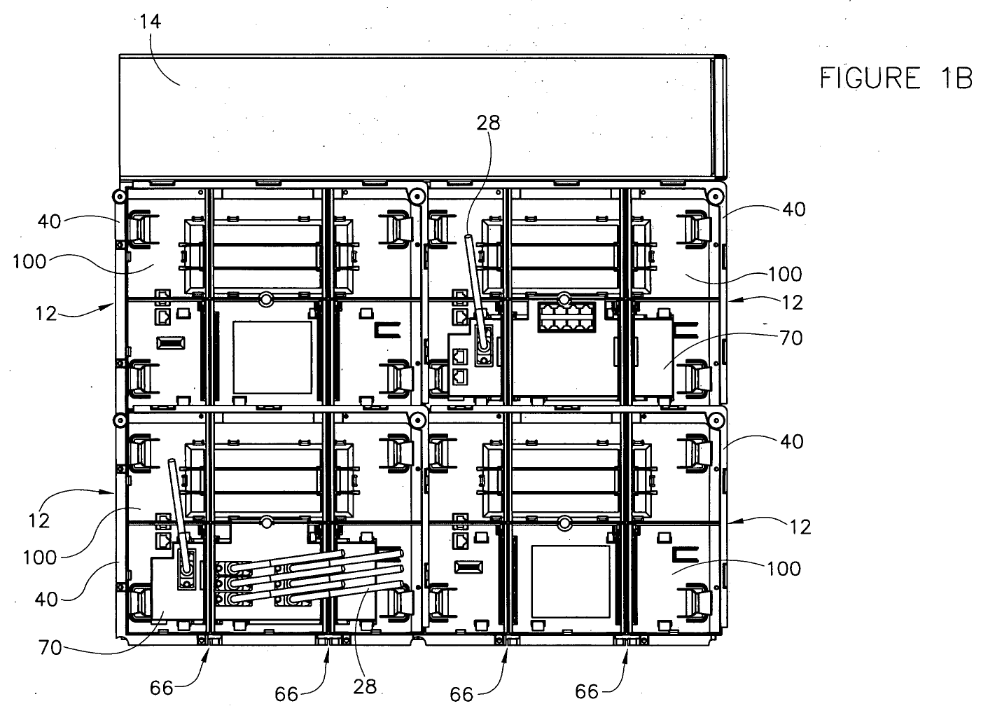

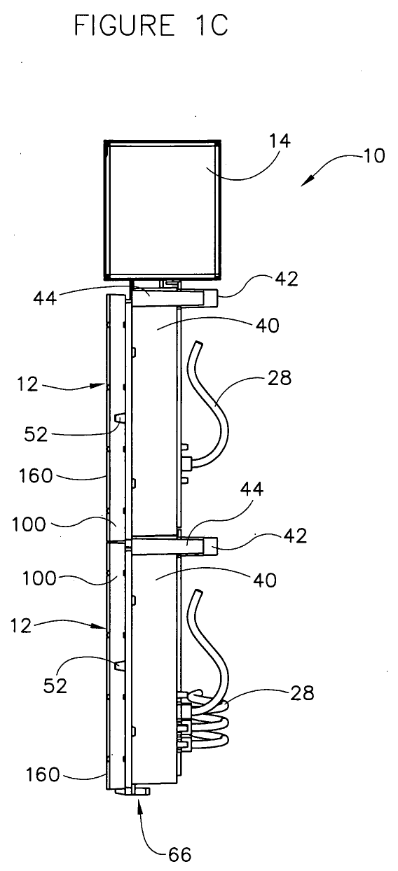

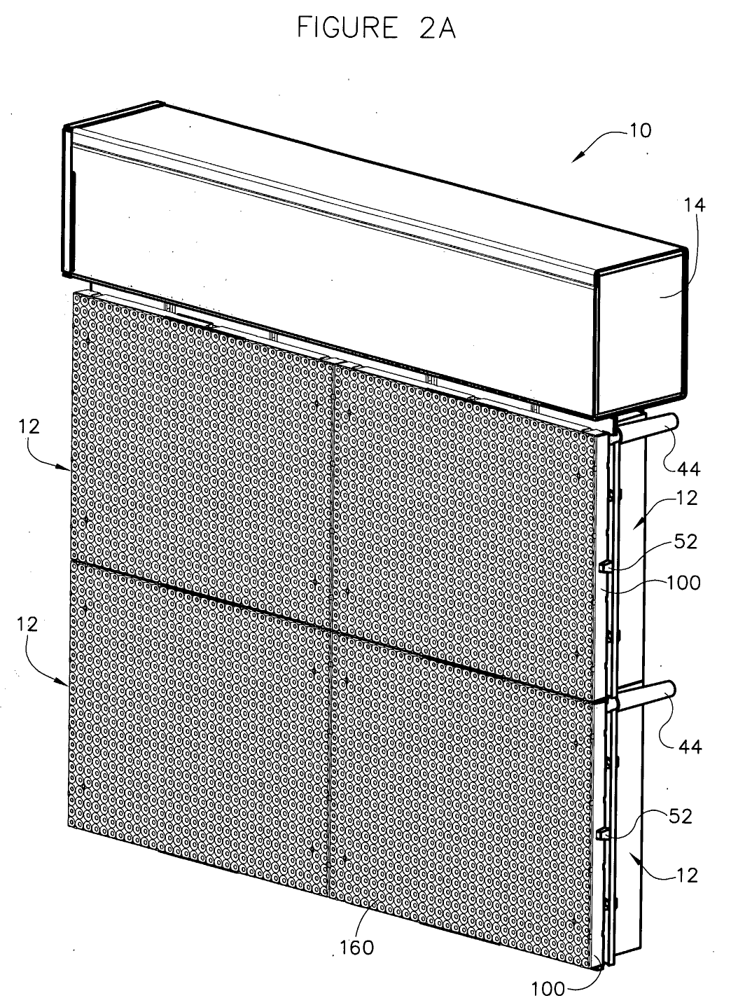

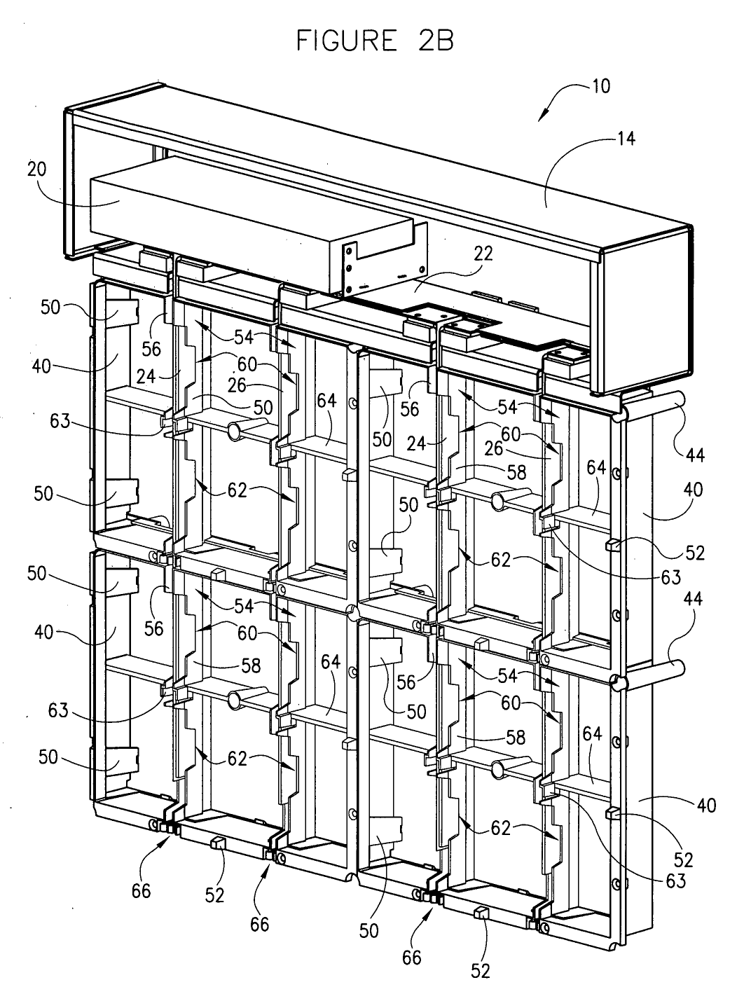

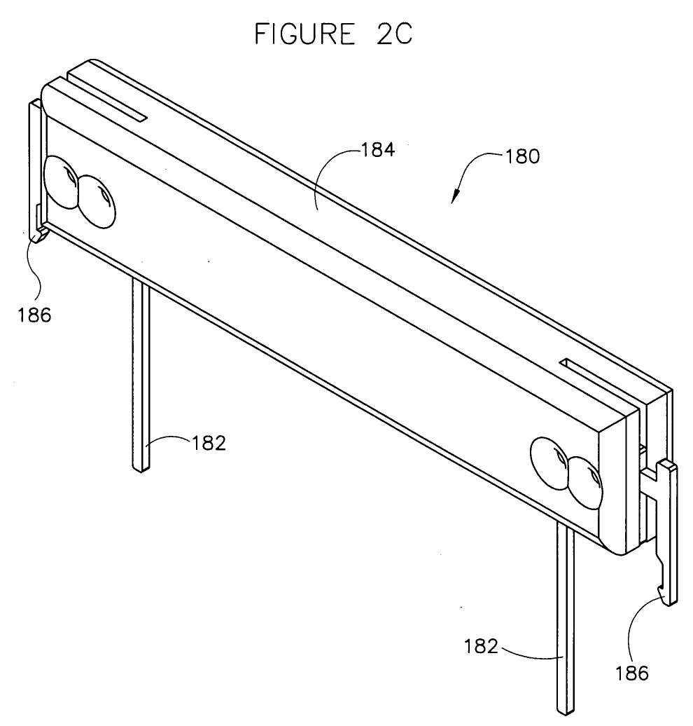

Referring to FIGS. 1A-1C and 2A-2B, a modular system for a display panel assembly 10 is shown according to an exemplary embodiment (shown for example to include a 2×2 array of four sub-panels 12 (e.g. “tiles” etc.), a power supply system and a communication system). Each sub-panel 12 is shown to include a single frame member and a single display unit. However, any suitable number of sub-panels may be assembled in any combination or permutation to form a display sign having a desired size and/or shape to suit a particular application. The desired number of sub-panels are interconnected to provide an assembly of the desired size and shape, and are shown connected to an enclosure 14 (e.g. junction box, power distribution box, etc.—shown for example along a top of the display panel assembly, but may be remote-mounted) for providing a source of power to the electrical components of the sub-panels. The enclosure may be connected to the display sign using any suitable method such as threaded fasteners, snap-lock connections, slide-lock connections, clips, adhesive, etc. (not shown). The enclosure 14 includes a power supply system having suitable power supply components, such as a power supply 20 (e.g. 120/240 VAC, 50/60 Hz) and a power bus with conductive members (shown as bus strips and insulating members 22, but may be cables or other suitable conductors) for interconnecting electrically conductive members (shown as bus bars 24, 26) (illustrated by way of example as interconnecting a top portion of the bus bars—see FIG. 2B). For the illustrated display panel applications using LEDs, a communication system having a communication device (e.g. data bus, etc.) is shown with wired communication/signal/data protocols, the sub-panels are shown to include suitable cables, such as low-voltage signal carrier cables (e.g. digital video input (DVI) cables 28 or the like) for interconnecting the electrical components of the sub-panels, and using suitable connectors (e.g. plugs, jacks, receptacles, etc.) of a conventional type (see FIGS. 1B-1C). According to one alternative embodiment, the communication device may be a modular data bus formed by suitable conductors fitted into (or otherwise connected to) the frame members so that mechanical connection of display units to the frame members also connects the display unit components to the modular data bus (e.g. in a “plug and play” like manner, etc.). According to another alternative embodiment, the data bus may be arranged for wireless signal communication to, and/or among, the sub-panels. The display panel assembly may be enclosed in any suitable structure (before or after assembly), such as a wall of a facility, a window, a weather-resistant housing, a monument-type object, a superstructure (e.g. for mounting two display panels assemblies in a “back-to-back” arrangement), or other suitable structure (not shown) to provide desired features such as a “finished” appearance, weather protection, access control, etc.

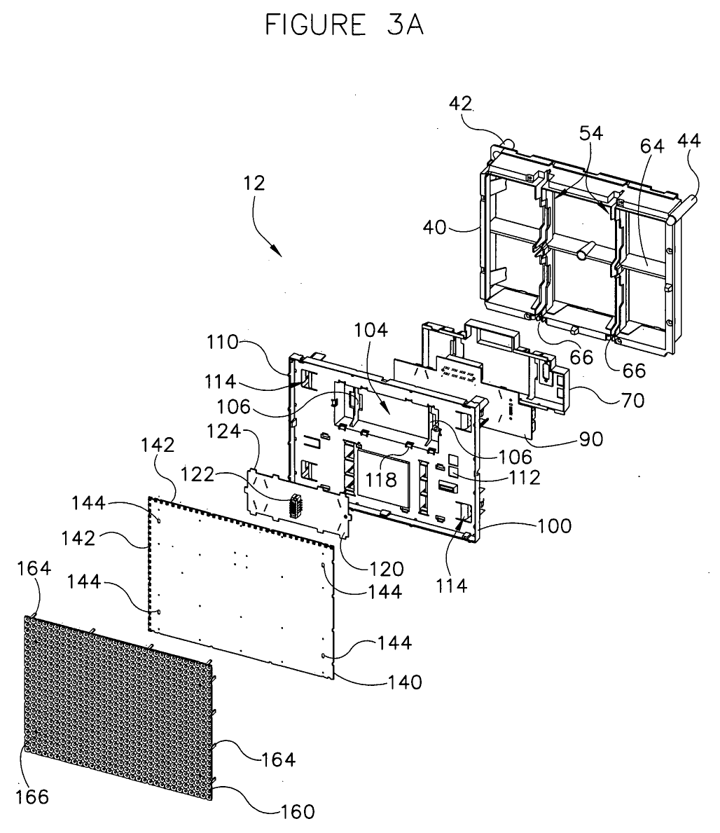

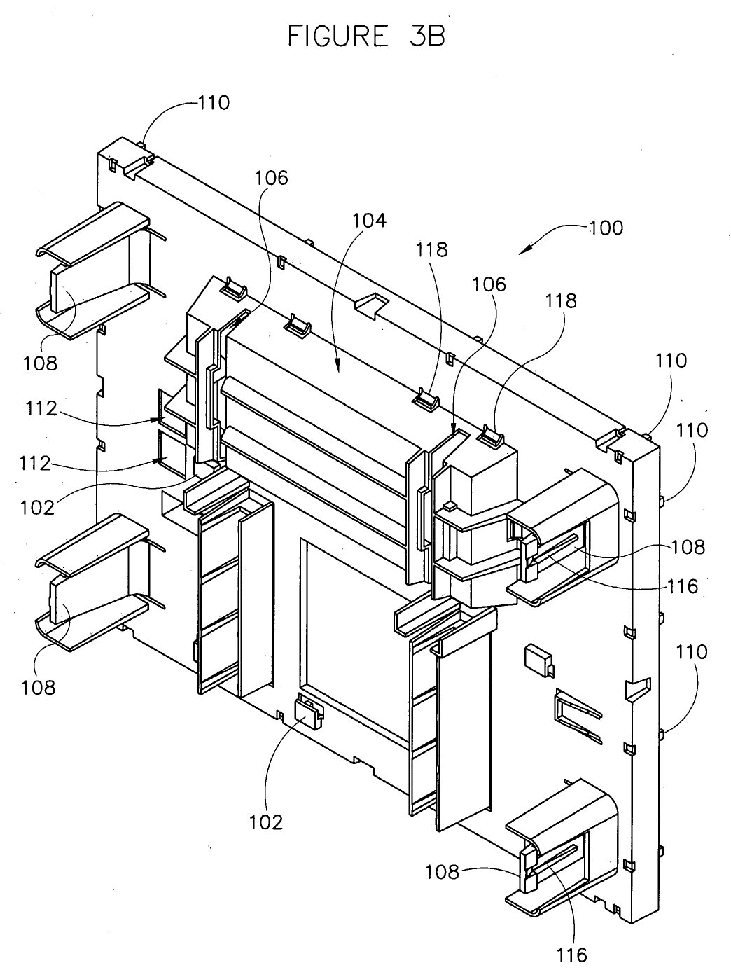

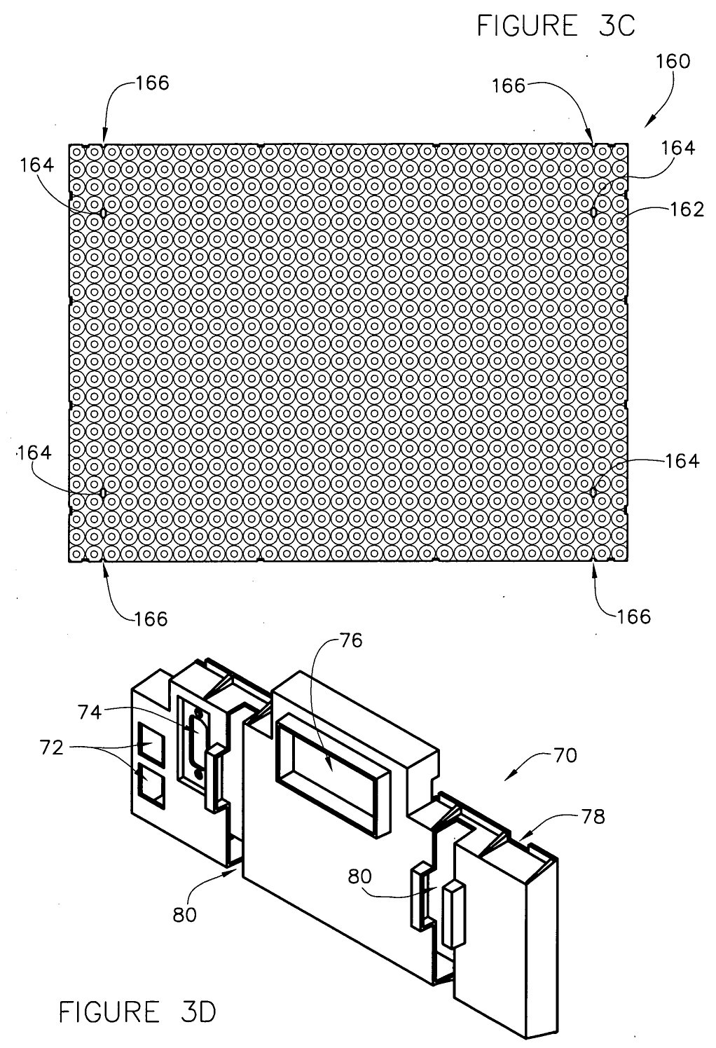

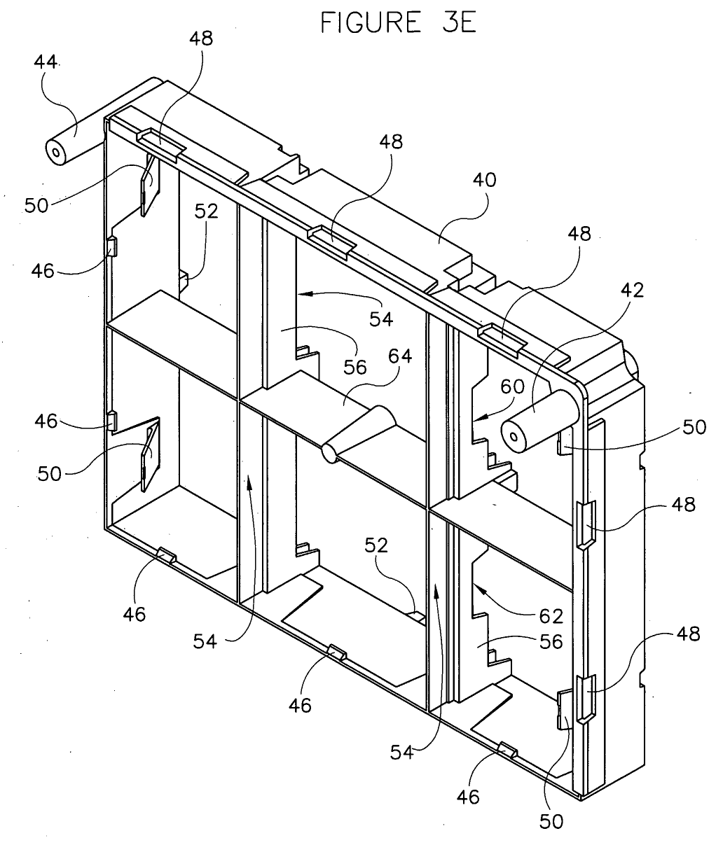

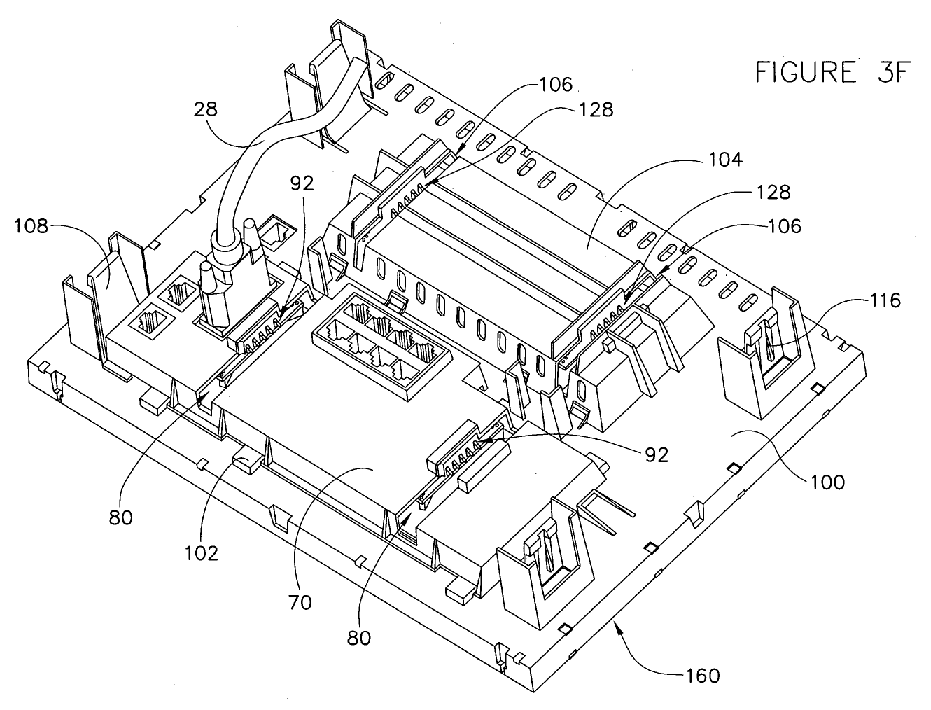

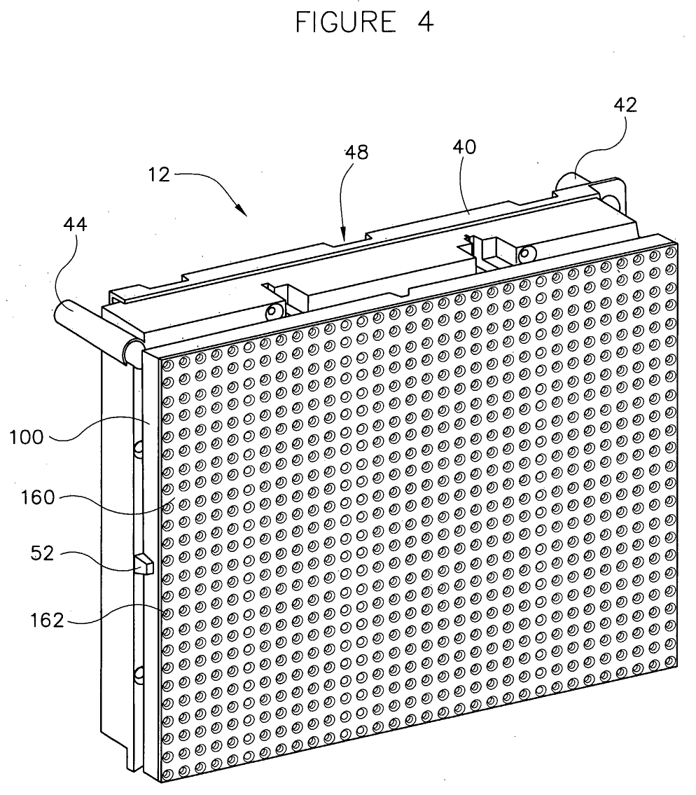

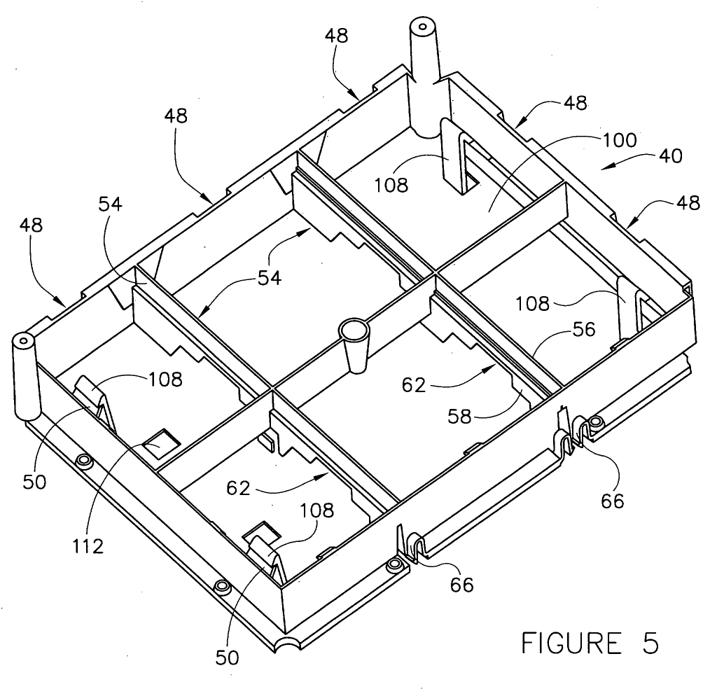

Referring to FIGS. 2A-3A, the modular components for a sub-panel of the modular assembly for a display panel are shown schematically according to an exemplary embodiment. The modular components include a frame member 40 (e.g. mounting ring, bracket, etc.). The modular components also include a display unit (connectable to the frame member), which comprises a first housing (e.g. cap, etc.—shown as a DVI splitter and/or DVI turbo cover 70) for housing a first printed circuit board (PCB) 90 for DVI distribution and/or signal amplification (e.g. “turbo” etc.). The display unit also includes-a second housing (e.g. mounting plate, cover, etc.—shown as a rear panel 100) configured to receive a second PCB 120 for providing DC voltage conversion, and a third PCB 140 that functions as a driver board and having an array of LEDs mounted to a front surface, and a third housing (e.g. louver, contrast plate, cover, etc.—shown as a front panel 160). The modular components are configured for assembly according to any one of several convenient methods. For example, the frame members 40 may be connected into a frame network (e.g. grid, matrix, “skeleton” etc.) having rows and columns of interconnected frame members. The remaining components of the sub-panel 12 may be assembled into a display unit (e.g. cassette, cartridge, module, “block” etc.). The frame network is intended to provide a properly aligned “foundation” upon which the display unit is directly connectable to a create a display panel assembly. Formation of a frame network into a properly aligned structure is intended to permit separation of a generally “rough” portion of the work (i.e. construction of the “foundation”) from a more “delicate” portion of the work (i.e. assembly and connection of the electronic components of the display units). By further way of example, the modular components may all be assembled into a modular sub-panel, and any number of modular sub-panels may be interconnected to form a display panel assembly. In yet another example, the modular components may be assembled and interconnected in any suitable arrangement or sequence to facilitate the needs of particular application (e.g. part availability, schedule, weather conditions, installation site accessibility, etc.). The modular frame member is shown for use with a single modular display unit. However, according to alternative embodiments, a single modular frame member may be configured for use with two or more display units.

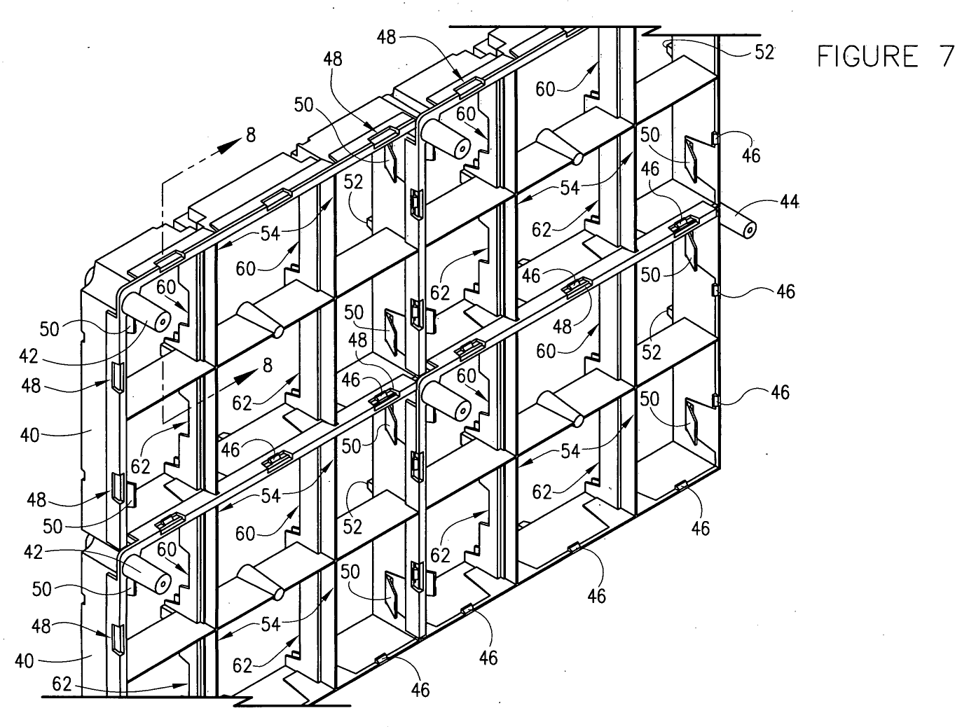

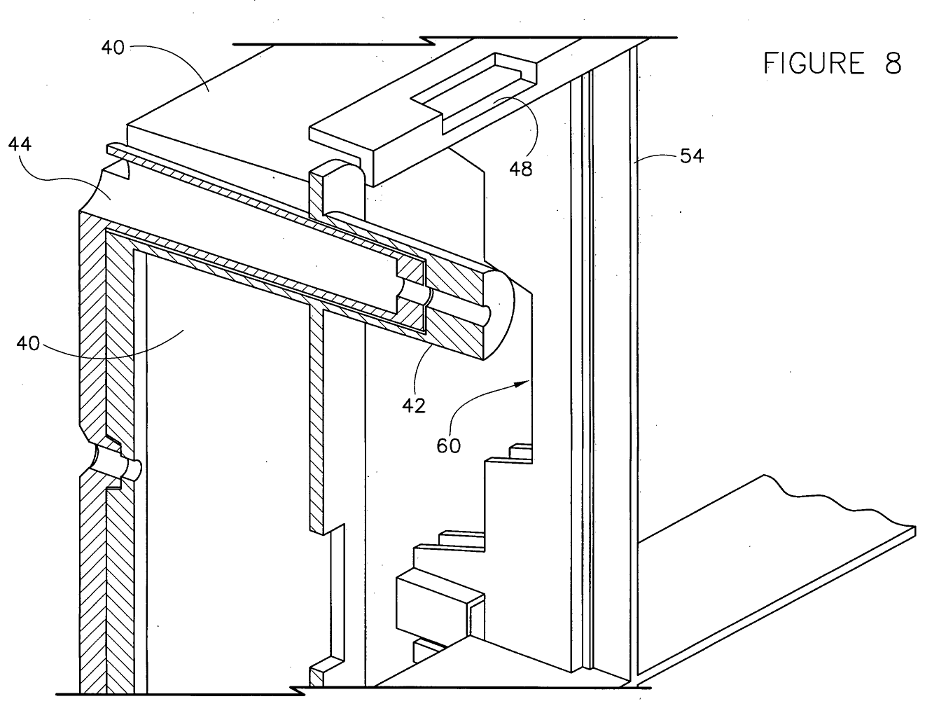

Referring to FIGS. 2B and 3E, a modular frame member 40 component is shown according to one embodiment. Frame member 40 is shown as a generally planar rectangular member having a sleeve (e.g. socket, receptacle, etc.—shown as a first tubular member 42) at a first corner and another sleeve (e.g. projection, post, etc.—shown as a second tubular member 44) at a second corner (shown for example as located at the top corners). The tubular members are shown having a generally frustoconical shape, but may be provided as cylindrical, cone-shaped, etc. The first tubular member 42 on one frame member 40 is sized to receive the second tubular member 44 on another (adjacent) frame member 40 to interconnect the frame members (see FIG. 7) in a certain predetermined manner so that the frame members are arranged and connected in a proper orientation and the frame members of the network are properly aligned to present a substantially uniform appearance (e.g. to preserve visual acuity and minimize “mismatch” or parallax distortion detectable by an observer) from the pixels of the display units attached to the network. The tubular members 42, 44 are shown to interface in a “mating” or “nesting” relationship (see FIG. 8) and may be secured to one another using a threaded fastener or other type of conventional fastener. According to an alternative embodiment, the tubular members may interconnect using a snap-fit type arrangement (e.g. barbs, ribs, etc.), an interference fit, adhesive, etc. According to another alternative embodiment, the frame member may be formed having a non-planar form (e.g. curved, convex, concave, etc.) and the frame may be provided in additional shapes (e.g. triangular, circular, semi-circular, etc.) to increase the available options for possible shapes of the display panel assembly. Further, the sleeves may be provided having any suitable structure for mating in a projection-and-socket arrangement.

Referring further to FIGS. 3E and 7 the frame members 40 include resilient tabs 46 (e.g. fingers, prongs, wings, etc.) shown schematically along the rear bottom and sides of the frame member 40 that are configured to engage (e.g. by snap-fit, etc.) a receptacle 48 (e.g. slot, aperture, window, etc.) provided along the top and sides of another (adjacent) frame member 40 (see FIG. 7). The interconnection of the tubular members 42, 44 and the tabs 46 and receptacles 48 are intended to permit interconnection of adjacent frame members 40 in a certain predetermined arrangement to facilitate correct assembly and alignment, so that the frame members 40 may be quickly and easily assembled in a factory or at a jobsite. The frame members 40 are also shown to include retainers 50 (e.g. fingers, tabs, wings, etc.) that are configured to receive and retain the display unit as a whole, by interconnecting with rear panel 100 (e.g. in a snap-fit or snap-connect relationship, etc.). Frame members 40 are also shown to include positioners 52 (e.g. tolerancing tabs, etc.—see FIGS. 1C and 2B) intended to facilitate proper positioning and alignment of components of the sub-panel 12 within the frame member 40. According to alternative embodiments, the tabs, receptacles and retainer may be provided in any desirable shape (e.g. interlocking ribs and channels, etc.) and location to facilitate interconnection of the frame members and the positioners may be provided in any suitable shape (e.g. alignment pins, ribs, channels, etc.) and location to facilitate alignment of the components of the sub-panel within the frame member.

Referring to FIGS. 2B, 3E and 5, the frame members 40 are also shown to include cross members 54 (e.g. channels, struts, ribs, braces, supports, etc.—shown schematically as two cross members 54) extending from a top side to a bottom side of the frame member. Cross members 54 include side walls 56, 58 with a longitudinal recess (e.g. groove, slot, pocket, etc.) therebetween configured to receive and retain a bus bar member of a modular power bus (shown as two bus bar members 24, 26—see FIGS. 2B, 9 and 10). The bus bars 24, 26 are shown extending from bus strips 22 in enclosure 14 to each of the frame members 40 “stacked” in a column associated with a particular set of bus bars. According to one embodiment, a first bus bar 24 is a “power” bus bar and includes two strips made from a metallic material (e.g. aluminum, copper, steel, etc.) that are laminated together with an insulating (e.g. dielectric) member layered or positioned therebetween so that the power bus bar 24 has two conducting strips separated by an insulator. A first strip is an electrically “positive” conductor (e.g. +24 VDC). A second strip is an electrically “negative” conductor (e.g. −24 VDC) for conducting power from power supply 20 via corresponding layers of the bus strip 22 to the electrical components of each sub-panel 12 in a column (e.g. stack, etc.) associated with a particular set of bus bars. A second bus bar 26 is an electrical “ground” (e.g. earth) bus bar. The bus bars 24, 26 are configured to snap-fit or “seat” within the recess and between the side walls 56, 58 of their respective cross member 54. The side walls 56, 58 are intended to provide an insulating surface along a portion of the exterior of each bus bar and are intended to minimize exposure of the electrically “live” surfaces of the bus bars and to minimize incidental contact therewith. The side walls 56, 58 also include two sets of “windows” (shown schematically as an “upper set” of windows 60 and a lower set of windows 62) providing access to a conductive surface of each side of the bus bars 24, 26 for connection to the electrical components of the sub-panel 12 (to be further described). The frame member 40 is also shown to include a laterally extending support member 64 that interconnects the sides of the frame member 40 and the cross members 54 to increase the structural rigidity of the frame member. According to an alternative embodiment, the bus bars may be formed from any suitable material and the power bus bar may be provided as two separate (e.g. physically separated) bus bars (e.g. one “positive” and one “negative”). Further, the bus bars may be configured to seat within suitable receptacles in the walls of the frame member and the cross members may be omitted. According to another alternative embodiment, a modular data bus may be integrated into the frame members by suitable data bus bars, or data bus strips may be integrated with the power bus bars.

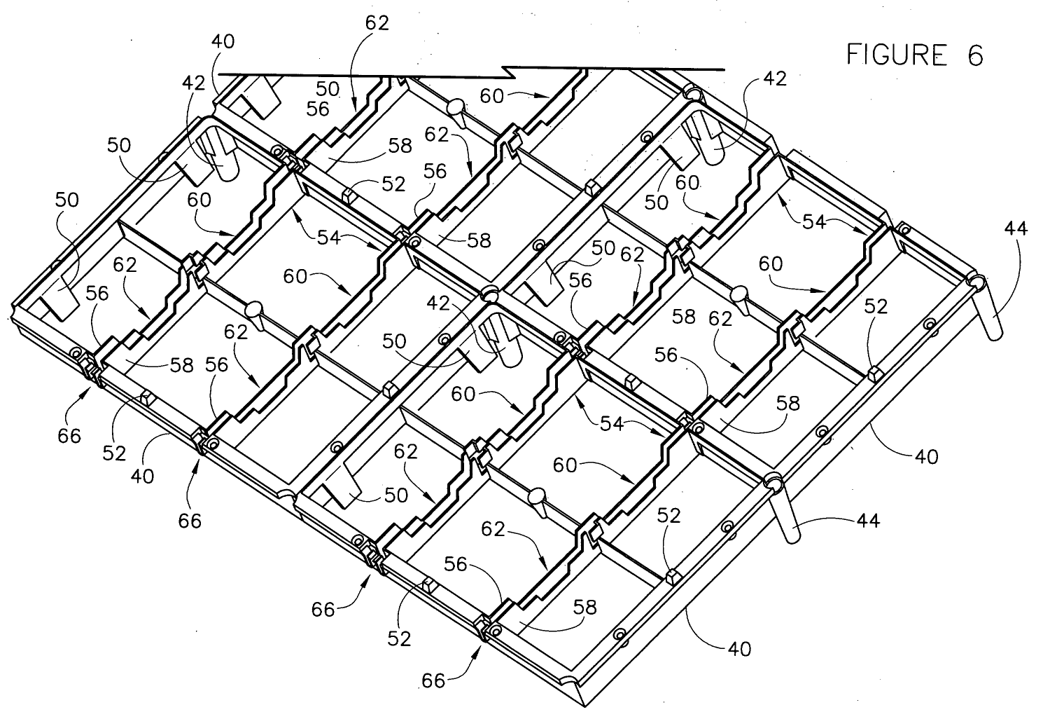

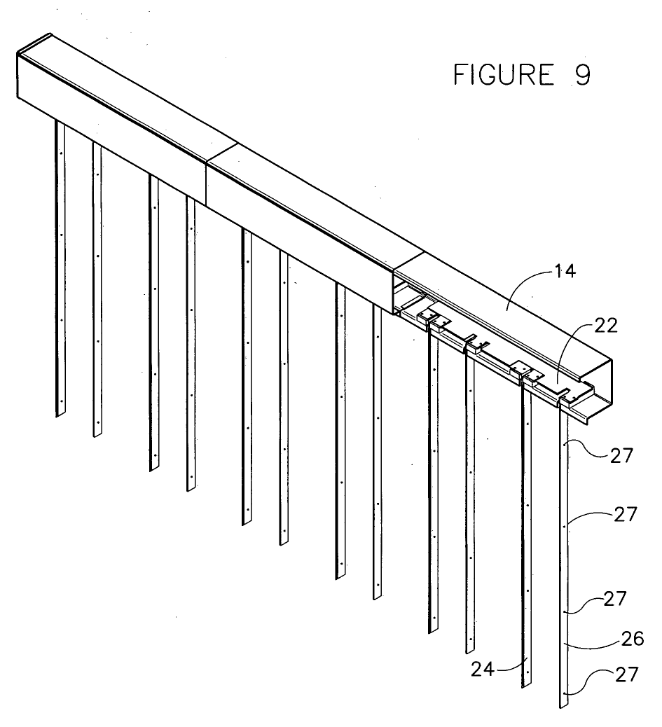

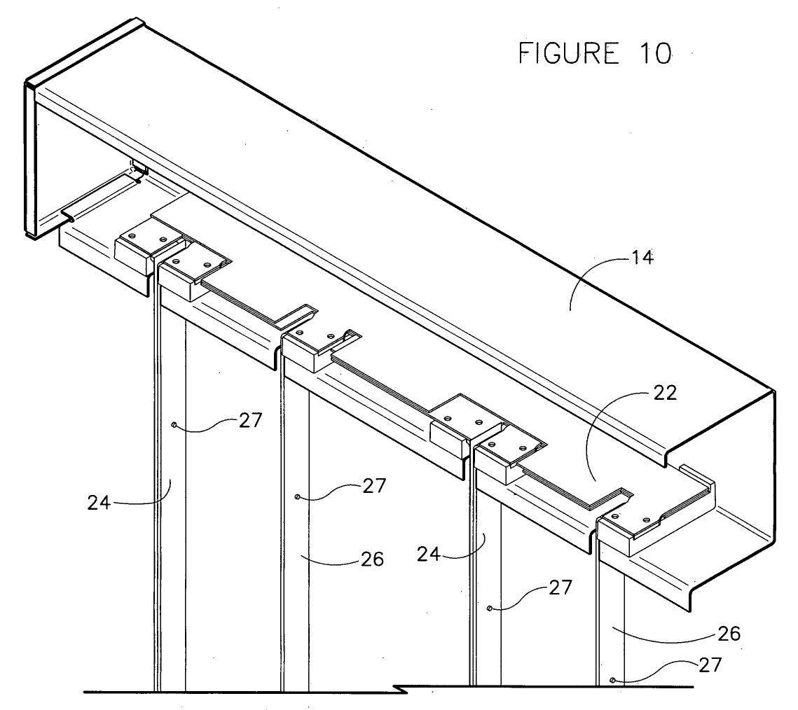

Referring to FIG. 5, the frame members 40 are also shown to include support structure intended to support the frame members 40 and display units of the sub-panels 12 on the bus bars 24, 26. The cross members 54 are further shown to include recesses 63 (e.g. pockets, receptacles, etc.) formed adjacent to support member 64 that are configured to receive corresponding projections (e.g. bumps, fingers, hooks, etc.—shown for example as pins 27 in FIGS. 9 and 10) on bus bars 24, 26 (e.g. in a snap-connect manner, etc.). Recesses 63 are intended to “seat” on pins 27 so that the bus bars 24, 26 provide vertical (e.g. Y axis) support to a column of frame members 40 in the frame network and to the display units attached to the frame members. Frame members 40 are also shown to include brackets 66 (e.g. loops, pockets, etc.) along a lower side. The brackets 66 are intended to have sufficient resiliency to “fit” over bus bars 24, 26 with a generally “tight” or interference type fit so that the bus bars 24, 26 provide horizontal (e.g. X axis and/or Z axis) support and stability to the frame members 40. Through the interaction of the brackets 66 and bus bars 24, 26, and the projections 27 and the recesses 63, the bus bars 24, 26 are intended to create a support system (e.g. spine, pillar, etc.) for the display panel assembly 10 so that the weight of the individual sub-panels 12 are at least partially supported and stabilized by the bus bars 24, 26, in addition to the structural strength of the frame members 40, and are intended to minimize or avoid the need for supplemental support structures to maintain the structural integrity of the display panel assembly 10. Any desirable number of frame members 40 may be interconnected together in any shape or arrangement to suit a particular display panel assembly. The enclosure 14 is connectable to a top side of the uppermost frame member 40 in each column, and the bus bars 24, 26 are connected to the bus strip 22 in the enclosure 14 and are provided in an appropriate length to extend downwardly to be received in the corresponding recesses of each frame member 40 in the column. According to one embodiment, the frame members are made from a plastic material in an injection molding process. According to a currently preferred embodiment, the material is Nylon® with a 33% glass fill, although any suitable material having the desired structural and electrically insulating properties may be used, and formed using any suitable process.

Referring to FIGS. 3A-3F, the remaining components of the sub-panel 12 may be assembled into a modular display unit (e.g. cassette, cartridge, module, element, “block” etc.), according to one embodiment, that electrically and mechanically “installs” or “connects” or “plugs in” to a frame member 40 in a single operation (e.g. by resilient contacts, frictional fit, snap-connect, etc.), so that the components may be easily installed and removed from any one of a network of frame members 40 as a single display unit. According to an alternative embodiment, the remaining components of the sub-panel may be individually connected to the frame member in any desired sequence.

Referring further to FIGS. 3A, 3D and 3F, the DVI cover 70 is shown having a shape and size to receive the first PCB 90, and having openings 72, 74, 76 for connection of input and output low voltage signal carrier cables 28 to corresponding connectors on a rear surface of the first PCB 90 (see FIG. 1A). For applications involving wireless control communication, the openings for connection of cables may be omitted. The DVI cover 70 is connectable to a rear surface of the rear panel 100 by connecting structure (shown schematically as slots or notches 78) on the DVI cover that engage projections (shown as tabs 102) on the rear panel 100 in a snap-fit relationship, so that the first PCB 90 is securely retained and enclosed between the DVI cover 70 and the rear panel 100. The DVI cover also includes openings 80 that permit resilient conductive elements (e.g. stabs, fingers, etc.—shown schematically as contacts 92 in FIG. 3F) that extend rearwardly from the first PCB 90 to pass through the DVI cover 70 and engage an exposed surface on each side (i.e. the positive strip and the negative strip) of the power bus bar 24 and the ground bus bar 26 at a second set of windows 62 (shown as lower set of windows in FIG. 2B) on cross members 54 of frame member 40 for providing power to the first PCB 90 when the component(s) are connected to the frame member 40 and bus bars 24, 26.

Referring further to FIGS. 3A, 3B and 3F, the rear panel 100 also includes a receiving structure (shown as a recess 104, and sockets 118) configured to receive and align tabs 124 on the second PCB 120 in a snap-connect manner. Recess 104 includes openings 106 that permit resilient conductive elements (e.g. stabs, fingers, etc.—shown schematically as contacts 126 in FIG. 3F) that extend rearwardly from the second PCB 120 to pass through the rear panel 100 and engage an exposed surface on each side (i.e. the positive strip and the negative strip) of the power bus bar 24 and the ground bus bar 26 at a first set of windows 60 (shown as an upper set of windows in FIG. 2B) on cross members 54 of frame member 40 for providing electrical power to the second PCB 120 when the component(s) are connected to the frame member 40. The rear panel 100 is also shown to include retainers 108 (e.g. tabs, wings, etc.) extending from a rearward surface that are configured to coact or engage retainers 50 on frame member 40 in a locking relationship so that rear panel 100 can be securely and releasably coupled to the frame member 40 in a snap-fitting relationship. The retainers 108 are intended to provide generally “hidden” connecting structure that permits the modular display unit as a whole to be directly connectable to the frame members and removable from the frame members using a tool (to be further described) in a front-access manner without interfering with the desired aesthetic appearance of the display panel. Rear panel 100 may also include connectors 110 (e.g. tabs, hooks, etc.) configured to receive the third PCB 140 on a front surface of the rear panel 100 in a snap-fitting relationship and aligned so that electrical contacts (not shown) on a rear surface of the third PCB 140 electrically engage electrical contacts 122 on a front surface of the second PCB 120 (see FIG. 3A), so that the third PCB 140 is electrically interconnected to the bus bars 24, 26 via the second PCB 120 when the DVI cover 70, and first PCB 90, and rear panel 100, and third PCB 140 are interconnected and mounted to the frame member 40. The rear panel 100 also includes openings 112 to permit connection of cables 28 to connectors (not shown) on a rear surface of the third PCB 140. The rear panel 110 may also include connectors (e.g. tabs, hooks, etc.—not shown) configured to secure and retain the front panel to the rear panel, with the third PCB contained therebetween.

Referring to FIGS. 3A and 3C, the front panel 160 is shown according to an exemplary embodiment. Front panel 160 is shown as a generally planar element having an array of apertures 162 (e.g. cone-shaped apertures, etc.) configured to align with an array of LEDs 142 on a front surface of the third PCB 140 (shown as a portion of an array of 768 LEDs in the illustrated embodiment). However, the third PCB 140 may include any desirable number of LEDs, in any suitable color or arrangement suited to a particular application (such as, but not limited to, matrix displays, character displays, etc.). A corresponding number of apertures 162 are provided and aligned with the LEDs 142 so that light emitted from the LEDs 142 is visible through the apertures 162 to an observer. The apertures are shown generally in the shape of a cone configured to minimize obstruction from an intended viewing angle. The apertures may be “open” or the apertures may be “filled” with a clear or colored material (e.g. plastic, epoxy, etc.) to provide a desired visual image of light emitted from the LEDs. The apertures 162 are also intended to improve visual performance by inducing “shadows” over the LEDs when the display panel assembly 10 is exposed to light (e.g. sunlight, etc.). The front surface of the front panel 160 may also be provided with a desired color (e.g. black, etc.) intended to provide or increase contrast to the LEDs and intended to enhance the visual image projected by the array of LEDs. The front panel 160 is also intended to help protect the LEDs 142 and the surfaces of the third PCB 140 from inadvertent contact with foreign objects or materials, vandalism, contaminants (dust, dirt, etc.), UV rays, etc. The front panel 160 may be attached to the third PCB 140 by heat stakes or other suitable connector and may include tabs 164 (e.g. hooks, slots, etc.) for coupling the front panel 160 and third PCB 140 to the rear panel 100.

The DVI cover 70, first PCB 90, rear panel 100, second PCB 120, third PCB 140, and front panel 160 may be assembled as a display unit by interconnecting them in a snap-fitting manner. (Alternatively, the components may be connected using other methods such as clips, “Christmas-tree” type fasteners, threaded fasteners, heat staking, adhesive, etc.). Upon assembling the components 70, 90, 100, 120, 140 and 160 (or any suitable sub-combination as desired for a particular application) into a display unit, the display unit may be electrically and mechanically connected to a frame member 40 by inserting the display unit into the frame member 40 and engaging retainers 50 and 108 to form a sub-panel 12 of the display unit and frame member 40. The display unit may also be conveniently removed by front-access from the frame member (e.g. for maintenance, repair, replacement, etc.) using a pair of tools (see FIG. 2C). The front panel 160, third PCB 140 and rear panel 100 are each shown to include tool apertures 164, 144, 114 respectively (shown as four tool apertures) that are aligned with retainers 108 on the rear panel. The front panel 160 also includes an edge feature 166 (shown schematically as four edge features corresponding generally in location to the tool apertures) that facilitates gripping by an accessory such as a tool for removing the display unit. A tool 180 for removing the unit from the frame element 40 may be formed from shaped rigid wires 182 (e.g. pins, stabs, bars, etc. shown extending from a handle 184—see FIG. 2C), where each wire 182 is insertable through a corresponding set of tool apertures 164, 144, 114 to contact a “reverse ramp” 116 on retainer 108 to “flex” retainers 108 and 50 to disengage the connection between retainers 108 and 50, so that the display unit may be conveniently removed from the frame member and disengaged from the power supply system (e.g. bus bars 24, 26). The tool 180 is also shown to include catches 186 on opposite ends of handle 184 (e.g. made from or provided with an electrically insulating material) that are intended to engage edge features 166 on front panel 160 to facilitate “gripping” or “holding” the components to enhance removal of the components from the frame member 40. The catches 186 may be spring biased into an engagement position with the edge features, or may be configured for manual activation (such as by a lever or the like provided in the handle or otherwise coupled to the catches). According to one embodiment, a worker may use a pair of tools 180 to remove a display unit from a frame member by inserting the pair of wires 182 on each tool into a corresponding pair of tool apertures to contact the reverse ramp 116 and to engage the catches 186 with the edge features 166, so that the display unit is released from the frame member and the catches grip the edge features for withdrawal and removal of the display unit from the front of the display panel.

According to any exemplary embodiment, the present invention provides a modular system for constructing a display panel assembly from any number of modular sub-panels that may be provided in any suitable size and shape. A plurality of individual, modular frame members are joined together into a grid, matrix or network (e.g. in a two or three dimensional shape with rows and columns of frame members) intended to form the desired size and shape of the display panel assembly and are secured together by connecting structures and/or fasteners that permit assembly in a certain predetermined and approved configuration to form a grid or matrix of frame members. The frame members include various connecting structure for attachment to other frame members and for electrically and mechanically receiving the components of the sub-panel in a properly oriented and aligned manner. An enclosure is coupled to a top portion of the frame network or any other array of frame members (or otherwise operably associated with the frame network) to provide a housing for power supply and/or signal conveying equipment (e.g. computer controls/interfaces, transmitters, receivers, line filters, wiring, etc.). Bus bars are electrically connected with a suitable power supply within the enclosure and extend through a column (e.g. “stack”) of frame members to provide a common “base” for electrical connectivity of the electrical components of the sub-panels and to provide structural support (e.g. “spine(s)”) for the “skeleton” of individual frame members of an associated column of sub-panels. The modular electrical components and cover panels of the sub-panel are interconnected into a display unit or block that electrically and mechanically aligns with, and removably snap-connects to, retainers within the frame member for proper alignment and retention within the frame matrix. Electrical contacts on the electrical components of the sub-panel are also configured to electrically engage the bus bars (e.g. in a sliding frictional interaction, etc.) when the display unit mechanically connects into the frame member. The display unit may be simply and easily removed from the frame member by insertion of a tool through axially aligned apertures in the components that permit disengagement of the mechanical fastening elements (i.e. resilient retainers). The modular system is intended to permit convenient and correct construction of a larger display panel assembly from a plurality of sub-panel components with properly aligned mechanical and electrical elements at a factory or jobsite setting with minimal external fasteners, and in any shape and/or size by assembly of the modular components of the sub-panels (such as in a “building-block” like manner). The display panel assembly (or frame network) may be surrounded by any suitable structure (e.g. “finished,” “trimmed-out” etc.) that provides any one or more of a variety of desired qualities such as aesthetic appearance, environmental protection from weather elements, access control, etc.

According to alternative embodiments, the bus bars and frame members may be horizontally configured for arrangement in “rows” and the power supply enclosure may be provided at any suitable location to provide power to the bus bars (e.g. on a side of the frame matrix, below the frame matrix, behind the frame matrix, remotely located, etc.). Also, the modular components may be provided in shapes other than rectangular (e.g. triangular, circular, etc.) so that the display panel assembly may be constructed having any of a wide variety of overall-shapes and appearances. Further, frame members may be provided in “corner” configurations that are intended to permit the display panel assembly to extend in multiple planes (e.g. permit the display panel to be formed as a three dimensional assembly). According to other alternative embodiments, the electrical components of the sub-panels may be configured for wireless communication with a control system that may be programmed locally or remotely.

It is important to note that the construction and arrangement of the elements of the modular system provided herein are illustrative only. Although only a few exemplary embodiments of the present invention(s) have been described in detail in this disclosure, those skilled in the art who review this disclosure will readily appreciate that many modifications are possible in these embodiments (such as variations in features such as connecting structure, components, materials, sequences, capacities, shapes, dimensions, proportions and configurations of the modular elements of the system, without materially departing from the novel teachings and advantages of the invention(s). For example, the frame members and cover panels may be provided in any desirable shape or contour (e.g. curved, etc.) to achieve optimum interconnection of the modular sub-panels into a desired display panel assembly. Further, it is readily apparent that variations and modifications of the modular system and its components and elements may be provided in a wide variety of materials, types, shapes, sizes and performance characteristics. For example, the control of the electrical components of the sub-panel and communication among the sub-panels may be hard-wired, wired with quick-release fittings/connectors, or the components may communicate by any suitable wireless protocol. Accordingly, all such variations and modifications are intended to be within the scope of the invention(s).

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A modular system for a display panel assembly, comprising:
a plurality of modular frames connectable into a two-dimensional matrix of at least one row and at least one column of the frames;
at least one power bus connected along frames of one of the row and the column;
a plurality of modular display units connectable to the frames and the power bus; and
a communication device configured to communicate signals to the display units.

2. The system of claim 1 wherein the power bus comprises bus bars.

3. The system of claim 2 wherein the bus bars are configured to at least partially support the frames.

4. The system of claim 2 wherein the bus bars are connected to all of the frames in the column.

5. The system of claim 1 wherein the frames comprise a first connecting structure with a first portion and a second portion configured so that the first portion on one of the frames nests with the second portion on another of the frames.

6. The system of claim 1 wherein the display units are configured to connect with the frames in a snap-connect relationship.

7. The system of claim 1 wherein the display units are configured to mechanically connect to the frames and electrically connect to the power bus in a single operation.

8. The system of claim 1 wherein the display units comprise an array of LEDs.

9. The system of claim 1 wherein the communication device is configured for wireless communication.

10. The system of claim 1 wherein the communication device comprises cables.

11. The system of claim 1 wherein the display units comprise at least one aperture configured to receive a tool for disengaging and removing the display units from the frames.

12. A modular display system, comprising:
a plurality of modular frame members connectable to form a network;
at least one bus bar connectable to the frame members and configured to at least partially support the frame members in one of a row and a column of frame members in the network; and
a plurality of modular display units connectable to the frame members to form a display panel assembly.

13. The system of claim 12 wherein the frame members further comprise a first retainer structure and the display units further comprise a second retainer structure, the first retainer structure and the second retainer structure configured to interlock in a snap-connect relationship.

14. The system of claim 12 wherein the frame members further comprise positioners configured to align the display units.

15. The system of claim 12 wherein the frame members further comprise at least one projection and at least one socket configured to interface in a nesting relationship for connection of adjacent frame members.

16. The system of claim 12 further comprising a data bus for communicating signals to the display units.

17. The system of claim 12 wherein the frame members further comprise brackets configured to be supported by the bus bar.

18. The system of claim 12 wherein the display units and frame members are configured to mechanically and electrically interconnect in a plug-in relationship.

19. The system of claim 12 wherein at least one bus bar extends along each column of frame members in the network.

20. The system of claim 12 further comprising an enclosure coupled to the network and housing one or more power supply components configured to interface with the bus bar.

21. The system of claim 12 wherein the display units comprise a rear panel, a driver board, an array of LEDs, and a front panel having an array of apertures aligned with the array of LEDs.

22. The system of claim 21 wherein the rear panel and the front panel comprise at least one aperture and at least one edge feature configured to receive a tool for disengaging a connection between the frame members and the display units, so that the display units can be removed from the frame members.

23. The system of claim 22 wherein the connection is formed by coacting resilient tab members.

24. A modular frame member for receiving a modular display element of a display panel assembly, comprising:
a base;
a socket and a projection coupled to the base, the socket on the base configured to receive the projection on another base to connect and align adjacent frame members; and
a connecting structure configured to receive the display element.

25. The modular frame member of claim 24 further comprising a receiving structure configured to receive a bus bar.

26. The modular frame member of claim 25 further comprising a bracket configured to be supported on the bus bar.

27. The modular frame member of claim 24 wherein the connecting structure comprises at least one resilient tab.

28. The modular frame member of claim 24 further comprising at least one positioner configured to align the display element.

29. A method of assembling a modular display panel, comprising:
requesting that a plurality of interconnectable modular frames and modular display units be delivered to a first location;
connecting the frames at the first location to form a network;
connecting at least one bus bar to at least one of a row and a column of frames in the network; and
connecting a plurality of modular display units to the frames.

30. The method of claim 29 further comprising the step of providing a data bus for communicating signals to the display units.

31. The method of claim 30 wherein the data bus is configured for wireless communication of signals.

32. The method of claim 29 further comprising the step of supporting the display units on the bus bars.

33. The method of claim 29 wherein connection of the display units to the frames also electrically couples the display units to the bus bars.

34. The method of claim 29 further comprising the step of assembling the display units from at least a front panel, a rear panel, a driver board and a plurality of LEDs.

35. The method of claim 29 further comprising the step of shipping the frame members, the bus bars and the display units for assembly into a display panel at a jobsite.

36. A modular display panel assembled according to the method of claim 29.
